(19) United States
(12) Patent Application Publication
(10) Pub. No.: US 2022/0148070 A1
(43) Pub. Date: May 12, 2022

(54) ORDERING SYSTEM AND SERVER SYSTEM

(71) Applicant: CANON KABUSHIKI KAISHA, Tokyo (JP)

(72) Inventor: Yuya Tanaka, Kanagawa (JP)

(21) Appl. No.: 17/506,346

(22) Filed: Oct. 20, 2021

(30) Foreign Application Priority Data
Nov. 12, 2020 (JP) 2020-188681

(51) Int. Cl. G06Q 30/06; G03G 15/00

(52) U.S. Cl. CPC G06Q 30/0633; G03G 15/5016

(57) ABSTRACT

An ordering system includes a recording apparatus, which records an image by use of recording materials contained in cartridges, and a server system, which is capable of communicating with the recording apparatus, wherein the recording apparatus sends status information, which includes values of remaining amounts of the recording materials of the cartridges mounted on the recording apparatus, and wherein the server system is equipped with a receiving unit configured to receive the status information, and an ordering unit configured to provide an instruction for ordering a replacement of a cartridge for which a replacement has not been ordered yet from among the cartridges mounted on the recording apparatus in a case where the status information indicates that there is a cartridge whose value of the remaining amount of the recording material is less than a predetermined threshold value and a replacement thereof has not been ordered yet.

### BACKGROUND

### Field

The present invention relates to a technology for ordering consumables for a recording apparatus.

### Description of the Related Art

In recent years, a recording apparatus capable of connecting to the Internet and communicating with a WEB server has been introduced. Japanese Patent Laid-Open No. 2002-99594 (hereinafter referred to as Document 1) proposes a system in which a recording apparatus detects a state regarding the remaining amount of a consumable part such as an ink cartridge or a toner cartridge, and, in a case where the remaining amount of the consumable part becomes equal to or less than a predetermined threshold value, the consumable part is ordered.

However, in the technology of Document 1, delivery is performed every time a consumable part (also referred to as consumables) that is equal to or less than the threshold value appears, and thus the delivery efficiency is not preferable.

### SUMMARY

An ordering system according to an embodiment of the present invention includes a recording apparatus, which records an image by use of recording materials contained in cartridges, and a server system, which is capable of communicating with the recording apparatus, wherein the recording apparatus sends status information, which includes values of remaining amounts of the recording materials of the cartridges mounted on the recording apparatus, and wherein the server system is equipped with a receiving unit configured to receive the status information which is sent from the recording apparatus, and an ordering unit configured to provide an instruction for ordering a replacement of a cartridge for which a replacement has not been ordered yet from among the cartridges mounted on the recording apparatus in a case where the status information received by the receiving unit indicates that there is a cartridge whose value of the remaining amount of the recording material is less than a predetermined threshold value and a replacement thereof has not been ordered vet.

Further features of the present disclosure will become apparent from the following description of exemplary embodiments with reference to the attached drawings.

### BRIEF DESCRIPTION OF THE DRAWINGS

FIG. 1 is a diagram illustrating a configuration of a consumables ordering system;

FIG. 2 is a block diagram illustrating a hardware configuration of a server apparatus;

FIG. 3 is a block diagram illustrating a hardware configuration of a printer;

FIG. 4 is a sequence diagram up to a process of delivering consumables;

FIG. 5 is a flowchart of a process of sending status information;

FIG. 6 is a diagram illustrating status information;

FIG. 7 is a flowchart in which a printer management server sends an instruction for ordering consumables;

FIG. 8 is an ink management table stored in a database of the printer management server;

FIG. 9A through FIG. 9E are diagrams illustrating a flow of updating replacement ordering information according to a change in the ink remaining amounts;

FIG. 10 is a user management table stored in a database of a shop server; and

FIG. 11 is a flowchart in which a printer management server sends an instruction for ordering consumables.

### DESCRIPTION OF THE EMBODIMENTS

Hereinafter, an explanation will be given of embodiments of the present invention with reference to the drawings. Note that the following embodiments do not limit the present invention, and every combination of the characteristics explained in the present embodiments is not necessarily essential to the solution in the present invention. Note that the same configurations will be explained with the same reference signs.

### First Embodiment

### <Configuration of the Consumables Ordering System>

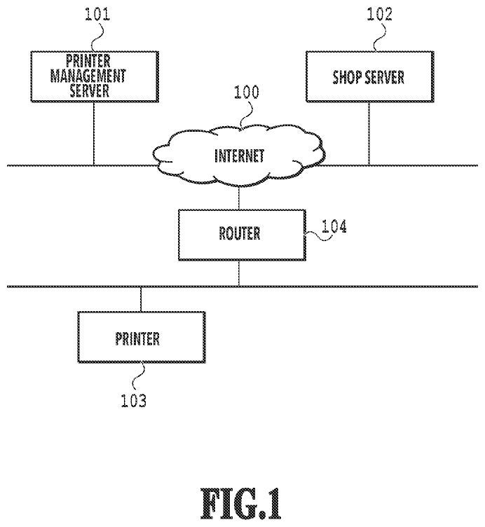

FIG. 1 is a diagram illustrating an example of the configuration of the consumables ordering system according to the present embodiment. Hereinafter, the configuration of the consumables ordering system according to the present embodiment will be explained with reference to FIG. 1. As illustrated in FIG. 1, the consumables ordering system according to the present embodiment includes the printer management server 101, the shop server 102, and the printer 103 which is a recording apparatus.

Each of the printer management server 101 and the shop server 102 is connected to the Internet 100. The printer 103 is capable of connecting to the Internet via the router 104. The printer management server 101 is capable of managing information that is sent from the printer 103 and providing the information that is sent from the printer 103 to the shop server 102 via the Internet TOO. For each communication, control through HTTP, XMPP, etc., is performed. Note that the protocol is not limited to these, and other protocols may be used.

### <Configuration of the Server>

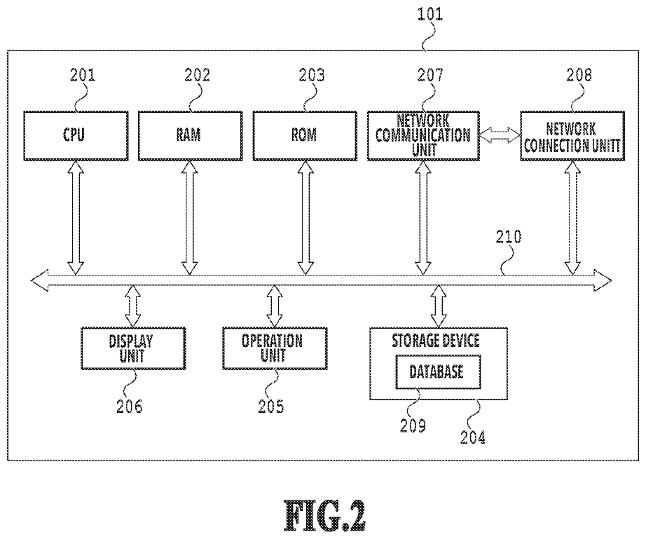

FIG. 2 is a block diagram illustrating an example of the hardware configuration of the printer management server 101. Hereinafter, the configuration of the printer management server 101 in the present embodiment will he explained with reference to FIG. 2. The printer management server 101 includes the CPU 201, the RAM 202, the ROM 203. the storage device 204, the operation unit 205, the display unit 206, the network communication unit 207, and the network connection unit 208.

The CPU 201 is a central processing unit fir controlling each unit in the printer management server 101. The RAM 202 serves as a working memory required for executing a program on the CPU 201. The ROM 203 is a read-only memory for storing a boot program required for launching a system. The storage device 204 is a device for storing a program to be executed by the CPU 201, the database 209. or various kinds of information, and, for example, is a non-volatile storage device such as a magnetic disk or a flash memory. The operation unit 205 includes a keyboard, a mouse, etc., for the user to perform various kinds of input operations. The display unit 206 is configured with an LCD. for example, so that various kinds of information are displayed and presented to the user. The network communication unit 207 is connected to a network such as the Internet 100 via the network connection unit 208 and performs various kinds of communications. The above-described units are connected to each other via the bus 210, so that it is possible to send and receive data to and from each other.

Note that it is assumed that the shop server 102 has the same hardware configuration as that of the printer management server 101, and thus the explanation thereof will be omitted. However, it is also possible that the shop server 102 has a hardware configuration that is different from that of the printer management server 101.

Further, in FIG. 2, although the example in which the printer management server 101 is configured with one server (information processing apparatus) will be explained, it is also possible that the printer management server 101 is configured with multiple servers. That is, each function may be executed by multiple servers operating in a linked manner. Similarly, the shop server 102 may also he configured with multiple servers. In the present disclosure, a configuration including one server or multiple servers is referred to as a server system.

### <Hardware Configuration of the Printer>

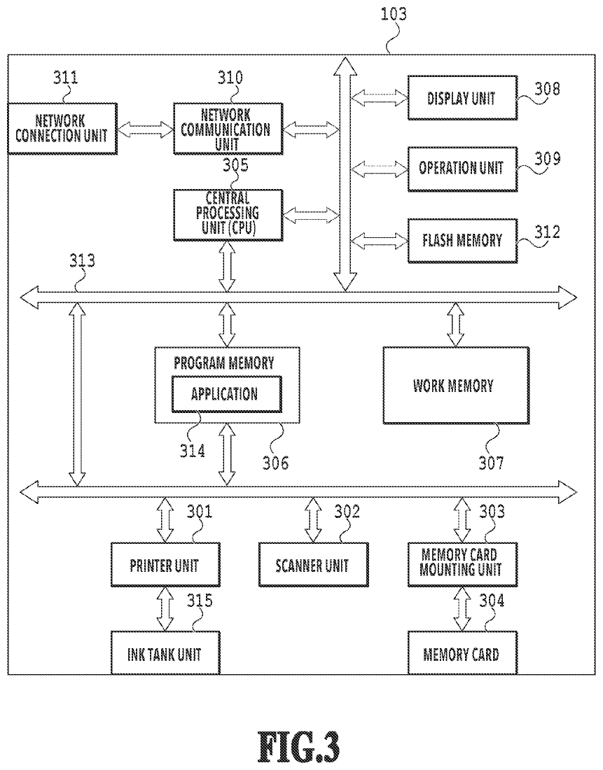

FIG. 3 is a block diagram illustrating an example of the hardware configuration of the printer 103. Hereinafter, the configuration of the printer 103 in the present embodiment will be explained with reference to FIG. 3. The printer 103 includes the printer unit 301, the scanner unit 302, the memory card mounting unit 303, the memory card 304, and the ink tank unit 315. Further, the printer 103 includes the CPU 305, the program memory 306, the work memory 307, the display unit 308, the operation unit 309, the network communication unit 310, the network connection unit 311, and the flash memory 312. Note that, although the printer 103, which is a multifunction peripheral, is explained as an example of the recording apparatus in the present embodiment, the recording apparatus to which the present embodiment can be applied does not have to be a multifunction peripheral. It is also possible to use an image recording apparatus such as a copier or a facsimile or use a printer that is not equipped with a scanner function. Further, although the recording apparatus of the present embodiment will be explained with the example of a printer that performs recording by use of ink, application to an apparatus that uses a recording agent such as toner is also possible.

In the printer 103, the printing function is implemented by the printer unit 301. Further, the scanner function is implemented by the scanner unit 302, and the storage function is implemented by the memory card mounting unit 303 and the memory card 304. The printer unit 301 records (that is, prints) an image on a recording medium such as a print sheet in an ink jet system, based on image data received from the outside, image data stored in the memory card 304, or the like. Further, the printer unit 301 also manages information of the ink remaining amounts and the sheet information including information of the number of loaded sheets.

The scanner unit 302 optically reads a document that is set on a platen glass (not illustrated in the drawings) and converts the document into digital data. Further, the scanner unit 302 sends image data, which is converted into a designated file format, to an external apparatus via a network and stores the image data in a storage area (not illustrated in the drawings) such as an HDD. Further, in order to implement the copying function, the image data which is generated by reading a document that is placed on the platen glass with the scanner unit 302 is transferred to the printer unit 301, and, based on the image data, the printer unit 301 records an image on a recording medium. The memory card 304 mounted on the memory card mounting unit 303 stores various kinds of file data. The various kinds of file data can be read out from an external apparatus via, a network for editing. Further, it is also possible to store the file data in the memory card 304 in response to an instruction from an external apparatus.

The CPU 305 is a central processing unit for controlling each unit in the printer 103. The program memory 306 is configured with a ROM, etc., and, in the program memory 306, various kinds of program codes and the application 314 for communicating with the printer management server 101 are stored. The module of the application 314 generates printer status information, which will be described later. The work memory 307 is configured with a RAM, etc. In the work memory 307, image data or the like is temporarily stored at the time of executing each service, and buffering is performed by use of the work memory 307. The display unit 308 is configured with an LCD, for example, and displays various kinds of information. The operation unit 309 includes a switch, etc., for the user to perform various kinds of input operations. The network communication unit 310 is connected to the router 104 via the network connection unit 311. That is, the network communication unit 310 is connected to a network such as the Internet 100 via the network connection unit 311, so as to perform various kinds of communications. In each kind of communication, control through HTTP, XMPP, etc., is performed. Note that the protocol is not limited to these, and other protocols may be used. The flash memory 312 is a non-volatile memory for storing image data, etc., received by the network communication unit 310. The above-described units are connected to each other via the bus 313, so that it is possible to send and receive data to and from each other. The ink tank unit 315 is equipped with an ink cartridge including an ink tank that contains the ink to be used in the printer unit 301. Note that, in a case where toner is used as a recording agent, a toner cartridge may he mounted. The ink cartridge mounted on the ink tank unit 315 is replaced with another ink cartridge by the user in a case where the contained ink runs out or the remaining amount is extremely low. That is, the ink cartridge mounted on the ink tank unit 315 of the present embodiment is one kind of consumables to be replaced with an ink cartridge for replacement in a case where the ink runs out.

### <Processing up to Delivery of a Replacement of an Ink Cartridge>

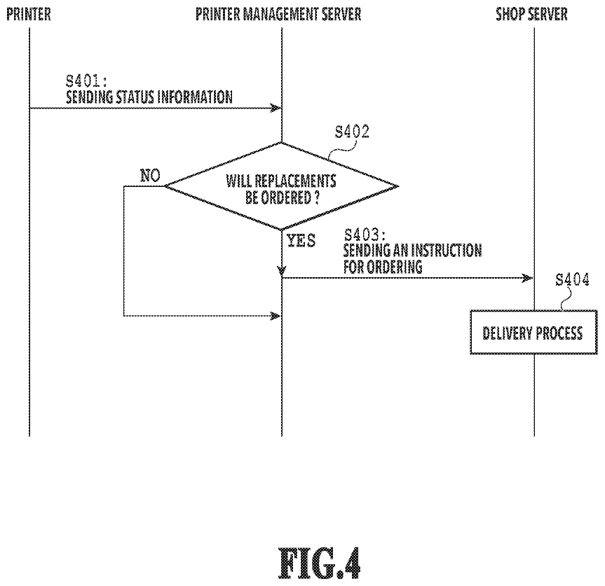

FIG. 4 is a sequence diagram related to the processing up to delivery of a replacement of an ink cartridge. Hereinafter, the processing up to delivery of a replacement of an ink cartridge in the present embodiment will be explained with reference to FIG. 4, etc. Furthermore, the series of processes illustrated in the sequence of FIG. 4 is performed by the respective CPUs of the printer 103, the printer management server 101, and the shop server 102 loading program codes stored in a disk device, etc., into a RAM and executing the program codes. Alternatively, a part or all of the functions in the steps of FIG. 4 may be implemented by hardware such as an ASIC or an electronic circuit. Note that the symbol “S” in the explanation of each process means that it is a step in the sequence diagram. Hereinafter, the subjects in the respective processes are the CPUs included in the printer 103, the printer management server 101, and the shop server 102.

In S401, the printer 103 sends printer status information (hereinafter referred to as status information) including information of an ink cartridge to the printer management server 101. In the present embodiment, the status information is information including the ID (identification information), color information, ink remaining amount information, etc., of each ink cartridge that is currently mounted on the printer 103, and the contents of the data is to be updated depending on the usage situation of the ink. Hereinafter, a flow in which the printer 103 sends status information to the printer management server 101 will be explained.

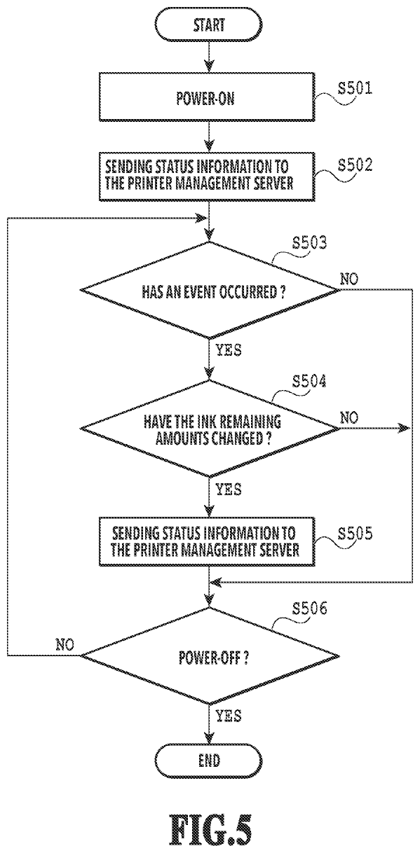

FIG. 5 is a flowchart illustrating the flow of the processing in which the printer 103 sends status information, which includes information of an ink cartridge, to the printer management server 101. The series of processes illustrated in the flowchart of FIG. 5 is performed by the CPU 305 of the printer 103 loading a program code stored in a disk device or the like into a RAM and executing the program code. Note that it is assumed that the printer 103 is in the power-off state before the series of processes illustrated in the flowchart of FIG. 5 is started.

The present flow starts in a case where the pressing of the power supply button of the printer 103 is detected. In S501, the CPU 305 changes the printer 103 from the power-off state to the power-on state. In S502, the CPU 305 sends the status information 600, which indicates the status of the printer 103, to the printer management server 101.

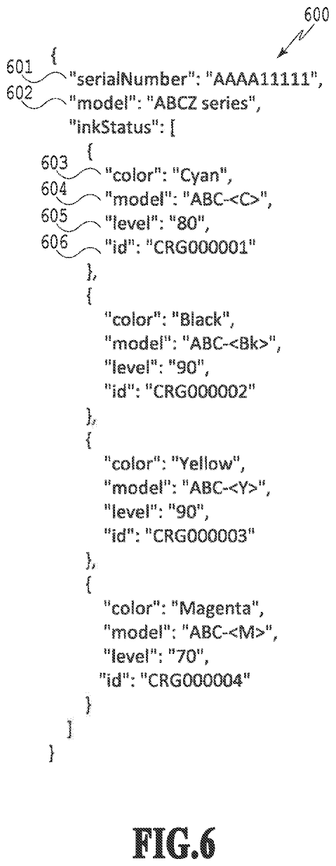

FIG. 6 is a diagram illustrating an example of status information. The status information 600 includes the serial number 601 of a printer, the model name 602, the color 603 for each ink cartridge, the model number 604, the ink remaining amount 605, and the unique ID (hereinafter referred to as an ink cartridge ID) 606 that identifies an ink cartridge. The ink cartridge ID is an ID that is unique to a cartridge regardless of the color of the contained ink. For example, the ink cartridge to which “CRG000001” is assigned is uniquely specified in this consumables ordering system.

In S503, the CPU 305 determines whether an event has occurred. The event is, for example, any operation being performed on the printer 103, such as performing printing or copying, opening the cover of the printer 103, etc. In a case where the determination result of the present step is Yes, the processing proceeds to S504. On the other hand, in a case where the determination result of the present step is No, the processing proceeds to S506.

In S504, the CPU 305 determines whether the ink remaining amounts of the ink cartridges mounted on the printer 103 have changed. In a case where the determination result of the present step is Yes, the processing proceeds to S505, On the other hand, in a case where the determination result of the present step is No, the processing proceeds to S506. In S505, the CPU 305 sends the status information 600 to the printer management server 101.

In S506, the CPU 305 determines whether the power supply of the primer 103 has been turned off. In a case where the determination result of the present step is Yes, the series of processes is ended. On the other hand, in a case where the determination result of the present step is No, the processing returns to S503 so that the processing from S503 is repeated.

As explained above, in the present embodiment, the CPU 305 of the printer 103 sends the status information 600 to the printer management server 101 at both of the timing where the power supply is turned on and the timing where printing or copying is performed and thus the remaining amounts of ink change.

Returning to the sequence of FIG. 4, the printer management server 101 determines whether to perform the process of ordering replacements in S402. In a case of ordering replacements, the processing proceeds to S403. In S403, the printer management server 101 sends an instruction for ordering replacements to the shop server 102.

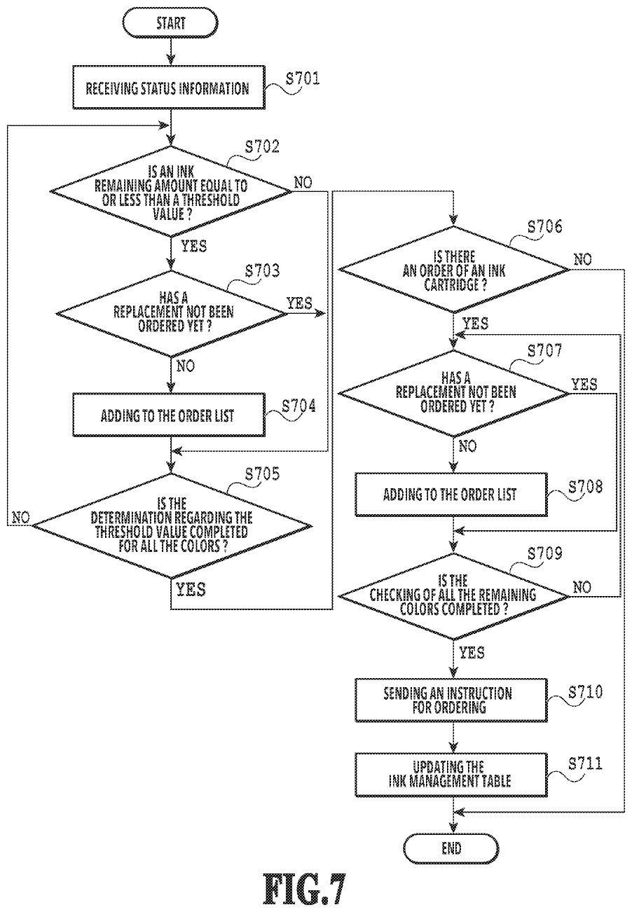

FIG. 7 is a flowchart illustrating a flow of the processing up to an instruction provided by the printer management server 101 to the shop server 102 for ordering an ink cartridge as a replacement. Note that the processes of the respective steps in FIG. 7 are performed by the CPU 201 of the printer management server 101 loading a program code stored in the ROM 203 or the storage device 204 into the RAM 202 and executing the program code.

In S701, the printer management server 101 receives the status information 600 which is sent by the printer 103. In S702, the CPU 201 determines whether the ink remaining amount included in the status information received in S701 is equal to or less than a predetermined threshold value. The predetermined threshold value is, for example, a given value such as 0, 10, or 20 indicating the proportion of the ink remaining amount. Further, although it is stated in the above description that “the remaining ink amount is equal to or less than a predetermined threshold value”, there is no problem even if “the remaining ink amount is less than a predetermined threshold value”, and the same applies to all the threshold values in the following embodiments. In a case where the determination result of the present step is Yes, the processing proceeds to S703. On the other hand, in a case where the determination result of the present step is No, the processing proceeds to S705.

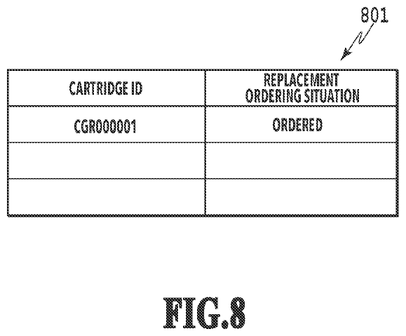

In S703, based on replacement ordering information which is stored in the ink management table 801, the CPU 201 performs the process of determining whether an order has not been placed for the corresponding ink cartridge ID yet. Here, an explanation will be given of the replacement ordering information, FIG. 8 is a diagram illustrating an example of the ink management table 801 which is stored in the database 209 of the printer management server 101. The ink management table 801 stores replacement ordering information. The replacement ordering information is information in which the ID of an ink cartridge is associated with the information indicating that a replacement of the ink cartridge has already been ordered. Note that the replacement ordering information does not include information indicating which ink cartridge was ordered as a replacement. That is, if it is assumed that the ink cartridge B is ordered as a replacement of the ink cartridge A, the stored information only indicates that a replacement of the ink cartridge A has been ordered. Therefore, such information indicating that the ink cartridge B has been ordered as a replacement of the ink cartridge A is not stored. Note that, in the present embodiment, it is only necessary to specify whether or not a replacement of the ink cartridge A has been ordered. Therefore, although the example in which information indicating that the ink cartridge B has been ordered is not stored, the present embodiment is not limited to this example. As the replacement ordering information, it is also possible that the information indicating that the ink cartridge B has been ordered as a replacement of the ink cartridge A is stored. In any case, it is only necessary to specify whether a replacement of the ink cartridge A has already been ordered. The CPU 201 obtains replacement ordering information from the ink management table 801 at a predetermined timing and newly stores replacement ordering information in the ink management table 801. Further, the CPU 201 does not delete the replacement ordering information stored in the ink management table 801. That is, even after the status information received from the printer 103 no longer includes the information of the cartridge ID, the replacement ordering information of the cartridge ID continues to be held in the ink management table 801.

Further, it is also possible that only the ink cartridge IDs are stored in the ink management table. In that case, it means that orders have already been placed for all the ink cartridge IDs stored in the ink management table. That is, it is also possible that the ink management table itself serves as replacement ordering information.

Returning to FIG. 7, the explanation is continued. As described above, in S703, based on the replacement ordering information stored in the ink management table 801, the CPU 201 performs the process of determining whether a replacement having the corresponding ink cartridge ID has not been ordered yet. In a case where the replacement has not been ordered yet, the processing proceeds to S704. On the other hand, in a case where the replacement has already been ordered, the processing proceeds to S705. in S704, the CPU 201 adds and holds the model number of the ink cartridge in the order list.

In S705, the CPU 201 determines whether the process of replacement ordering determinations for ink cartridges has been performed (in other words, whether the processes of S702 to S704 have been performed) for all the colors of the ink cartridges mounted on the primer 103. In a case where the determination result of the present step is Yes, the processing proceeds to S706. On the other hand, in a case where the determination result of the present step is No (in a case where there is an unprocessed color), the processing returns to S702, so that the processes of S702 to S704 will be repeated until the processing for the ink cartridges of all the colors is completed.

In S706, based on whether there is data in the order list, the CPU 201 determines the presence or absence of an ink cartridge which has not been equal to or less than the threshold value but needs to be ordered. An ink cartridge that needs to be ordered is an ink cartridge Whose replacement has not been delivered to the user. In the present embodiment, in a case where there is an ink cartridge that needs to be ordered, if there is another ink cartridge that has not been delivered to the user, the ordering process will be performed together as described later. Therefore, the processing after S707 is performed.

In S707, among the ink cartridges whose ink remaining amount does not reach the threshold value (the ink remaining amount is more than the threshold value) in S702, the CPU 201 determines whether there is an ink cartridge for which a replacement has not been ordered yet. Specifically, the CPU 201 refers to the ink management table 801 and, in a case where the replacement order information of the ink cartridge exists, it will be determined that the replacement has already been ordered, and, in a case where the replacement ordering information does not exist, it will be determined that the replacement has not been ordered yet. In a case where the replacement has not been ordered yet, the processing proceeds to S708, and, in a case where the replacement has already been ordered, the processing proceeds to S709.

In S708, the CPU 201 adds and holds the model number of the ink cartridge, for which it is determined in S707 that a replacement has not been ordered yet, in the order list. That is, the ink cartridges for which a replacement has not been ordered yet will also be included as the target of ordering a replacement at this timing.

In S709, the CPU 201 determines whether the process of replacement ordering determinations for ink cartridges has been performed for all the colors of the ink cartridges mounted on the printer 103, for which it is determined in S702 that the ink remaining amount does not reach the threshold value. In a case where the determination result of the present step is Yes, the processing proceeds to S710. On the other hand, in a case where the determination result of the present step is No (in a case where there is an unprocessed color), the processing returns to S707, so that the processes of S707 to S708 will be repeated until the processing for the ink cartridges of all the remaining colors is completed.

In S710, the CPU 201 sends a replacement ordering instruction including the order list and the serial number of the printer 103 to the shop server 102. In S711, the CPU 201 adds the IDs of all the ink cartridges added to the order list to the ink management table 801 as having already been ordered. The ink cartridge IDs herein added are IDs of the ink cartridges currently mounted on the printer 103, not the ink cartridge Ins of the ordered replacements. That is, the ink cartridge IDs added to the ink management table 801 indicates that replacements of the corresponding ink cartridges have already been ordered.

### <Specific Example>

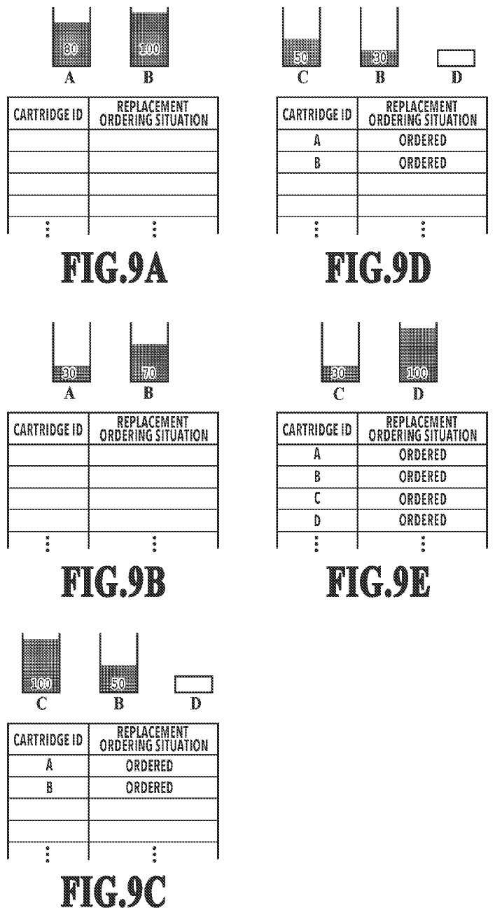

FIG. 9A through FIG. 9E are diagrams respectively representing the ink remaining amounts of the ink cartridges mounted on the printer 103 and the update situations of the replacement ordering information stored in the ink management table 801. Hereinafter, the flow of ordering replacements will be explained with reference to the specific example. That is, the explanation will be given by use of FIG. 9A through FIG. 9E which focus on the ink remaining amounts and the replacement ordering information. The explanation will be given on the assumption that the time series advances in the order of FIG. 9A to FIG. 9E. In FIG. 9A through FIG. 9E, the ink cartridge IDs are described in simplified forms for the sake of simplification of the explanation. Further, in the present embodiment, it is assumed that the printer 103 is equipped with the ink cartridges of two types of colors, i.e., Color and Black, and the threshold value of the ink remaining amount for replacement of each ink cartridge is 30.

In the state of FIG. 9A, both of the Color and Black inks mounted on the printer 103 are more than the threshold value, and replacements have not been ordered yet. A and B are the ink cartridge IDs of Color and Black, which are currently mounted on the printer 103, Hereinafter, the Color ink cartridge whose ink cartridge ID is A will be referred to as Color A,

In the state of FIG. 9B, the remaining amount of Color A is 30% and the remaining amount of Black B is 70%. Since the ink remaining amount of Color A has become equal to or less than the threshold value (equal to or less than 30%), the CPU 201 determines whether a replacement of Color A has not been ordered yet. At the moment, nothing is stored as the replacement ordering information, and thus the model number of the ink cartridge that has become equal to or less than the threshold value is added to the order list. Further, also regarding Black, although the ink remaining amount has not reached the threshold value (that is, the ink remaining amount is more than the threshold value), Black is added to the order list since a replacement has not been ordered yet. The CPU 201 executes an instruction for ordering the ink cartridge that are added to the order list and stores the information indicating that replacements of Color A and Black B have already been ordered as the replacement ordering information of the ink management table 801.

FIG. 9C is a diagram illustrating a state in which Color A whose ink remaining amount has become 0 is replaced with the delivered Color C whose ink cartridge ID is C. Further, the delivered Black D whose ink cartridge ID is D is stored as an inventory by the user since Black B has still been in use.

FIG. 9D is a diagram of a state in which the ink remaining amount of Black B has become equal to or less than the threshold value. In this state, by checking the replacement ordering information of the ink management table 801, the CPU 201 determines that a replacement of Black B has already been ordered. Therefore, the Black ink cartridge will not be added to the order list. That is, the ink cartridge less than the threshold value will not be ordered. In this case, the ordering process will not be performed even if another ink cartridge whose ink remaining amount is more than the threshold value has not been ordered yet. Therefore, as for Color C, although a replacement of the ink cartridge has not been ordered yet, Color C is not added to the order list. This is the same process as S706 of FIG. 7, Therefore, in the state of FIG. 9D, the processing ends without providing an ordering instruction.

FIG. 9E is a diagram illustrating a state in which the ink remaining amount of Color C is equal to or less than the threshold value and Black B whose ink remaining amount is 0 has been replaced with Black D. In this state, since a replacement of the color C has not been ordered yet, Color is added to the order list. In addition, since a replacement of Black D has not been ordered yet either, Black is added to the order list. Therefore, the CPU 201 executes an ordering instruction for replacements of both Color and Black ink cartridges, and the replacement ordering information is updated with the information that the replacements of Color C and Black D have already been ordered. The above is the flow of updating the ink remaining amounts of the ink cartridges mounted on the printer 103 and the replacement ordering information according to a change in the ink remaining amounts.

Returning to the sequence of FIG. 4, in S404, the shop server 102 performs the delivery process based on the model numbers and serial numbers of the ink cartridges of the target of ordering, which have been received from the printer management server 101. The shop server 102 obtains the address of the user, which is associated with the received serial numbers, from the later-described user management table 1001, so as to perform the process of delivering the ink cartridges as replacements.

### <User Management Table>

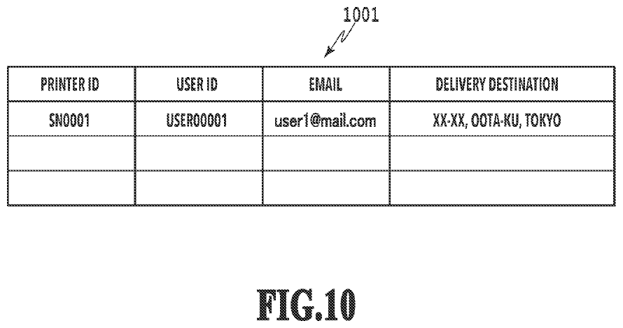

FIG. 10 is a diagram illustrating an example of the user management table 1001. Hereinafter, the user management table stored in the database 209 of the shop server 102 in the present embodiment will be explained with reference to FIG. 10. In the user management table 1001, necessary information is to be stored in accordance with a service contract for managing ink with the printer management server 101 after the user purchases the printer 103, for example. Specifically, the serial number, which is the identifier of the printer to be a target of the contract, is stored in association with the contractor's user ID, address, and e-mail address.

### <Effect of the Present Embodiment, Etc.>

According to the present embodiment, it is possible to improve the efficiency in shipping of consumables. That is, in a case where the remaining amount of a consumable becomes equal to or less than a threshold value, other consumables can be automatically delivered together. More specifically, in a case where the ink remaining amount of an ink cartridge becomes equal to or less than the threshold value, if a replacement of the ink cartridge has not been ordered yet, the replacements of other unordered cartridges can be ordered together with the cartridge and delivered regardless of the ink remaining amounts. Accordingly, the ink cartridges can be delivered efficiently. Further, since replacements are not delivered for the ink cartridges for which a replacement has already been delivered, double ordering can be prevented. Note that, in the above-described example, the printer management server 101 is configured with one information processing apparatus. However, the present embodiment is not limited to such a form, and it is also possible that the printer management server 101 is configured with multiple information processing apparatuses. That is, it is also possible that the function of the printer management server 101 is implemented by multiple information processing apparatuses performing separated processes.

Further, in the above-described example, although the printer management server 101 performs the process of providing an instruction for ordering a replacement of an ink cartridge, the present embodiment is not limited to such a form. For example, it is also possible to have such a form in which the printer 103 performs the process of replacement ordering determinations for ink cartridges so as to send an instruction for ordering to the shop server 102. Further, although the example in which the management server 101 holds the ink management table 801 by itself was explained in the present embodiment, there is no limitation as such, and it is also possible to read out or update a table that is held in an external apparatus, so as to manage the external table.

Further, although the target of an order is ink in the present embodiment, the target is not limited to ink as long as the target is a recording agent contained in a consumable cartridge, such as toner.

### Second Embodiment

In the present embodiment, an explanation will be given of a form in which the printer management server 101 makes determinations about the ink remaining amounts of ink cartridges with two threshold values so as to provide an instruction for ordering. In the first embodiment, in a case where it is determined in S702 of FIG. 7 that there is an ink cartridge whose ink remaining amount is equal to or less than a predetermine threshold value, even an ink cartridge whose ink remaining amount is more than the predetermined threshold value is added to the order list regardless of the ink remaining amount as long as the ink cartridge has not been ordered yet. The present embodiment has such a form in which an additional threshold value is provided for the ink remaining amount of an unordered ink cartridge, so that only ink cartridges less than the threshold value will be ordered. Note that, in the present embodiment, the explanations of the contents common to the first embodiment will be omitted as appropriate, and the aspects that are different from the first embodiment will be mainly explained.

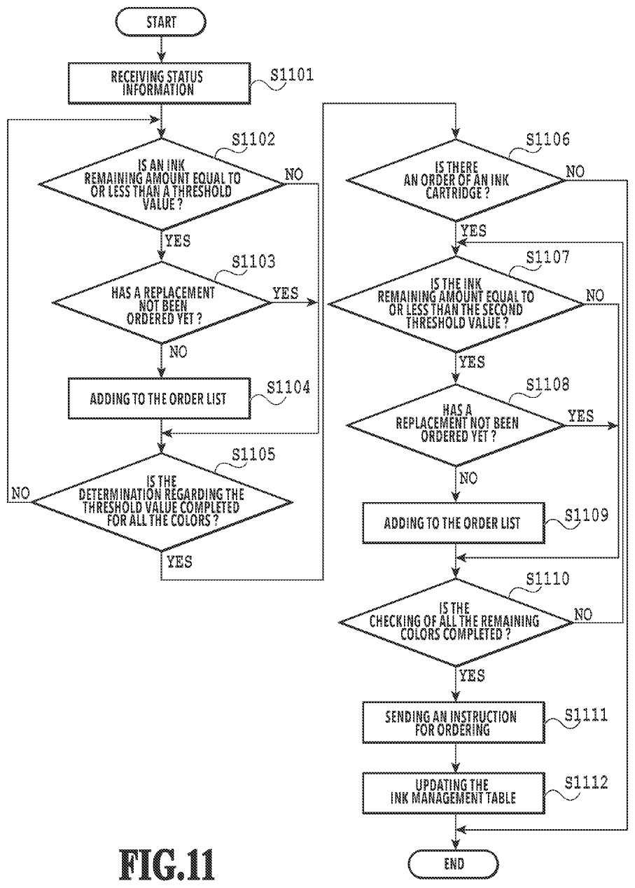

FIG. 11 is a flowchart illustrating a flow of the processing up to an instruction provided by the printer management server 101 of the present embodiment to the shop server 102 for ordering an ink cartridge as a replacement. Note that the processes of the respective steps in FIG. 11 are performed by the CPU 201 of the printer management server 101 loading a program code stored in the ROM 203 or the storage device 204 into the RAM 202 and executing the program code. Since the processes from S1101 to S1106 are the same as the processes from S701 to S706 of FIG. 7, the explanations thereof will be omitted.

In S1107, the CPU 201 determines whether the ink remaining amount is equal to or less than the second threshold value. Here, the second threshold value is different from the threshold value of S702 or S1102 and is a value indicating a state in which the ink remaining amount is large, such as 100 or 90. Further, since ink cartridges whose ink remaining amount is equal to or less than the second threshold value are determined from among the ink cartridges whose ink remaining amount is more than the predetermined threshold value, the second threshold value needs to be a value that is greater than the predetermined threshold value of S1102. If the determination result of the present step is Yes, it is determined that a replacement has not been ordered yet, and the processing proceeds to S1108. On the other hand, if the determination result of the present step is No, it is determined that a replacement has already been ordered, and the processing proceeds to S1110. Since the processes from S1108 to S1112 are the same as the processes from S707 to S711 of FIG. 7, the explanations thereof will be omitted.

### <Effect of the Present Embodiment>

According to the present embodiment, at the time of ordering an unordered replacement, an ink cartridge which is almost new in terms of the ink remaining amount can be excluded from the target of ordering. As a result, it is possible to reduce the period for which the user holds the inventory.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2020-188681, filed Nov. 12, 2020, which is hereby incorporated by reference wherein in its entirety.

What is claimed is:

1. An ordering system including a recording apparatus, which records an image by use of recording materials contained in cartridges, and a server system, which is capable of communicating with the recording apparatus,
wherein the recording apparatus sends status information, which includes values of remaining amounts of the recording materials of the cartridges mounted on the recording apparatus, and
wherein the server system comprises
a receiving unit configured to receive the status information which is sent from the recording apparatus, and
an ordering unit configured to provide an instruction for ordering a replacement of a cartridge for which a replacement has not been ordered yet from among the cartridges mounted on the recording apparatus in a case where the status information received by the receiving unit indicates that there is a cartridge whose value of the remaining amount of the recording material is less than a predetermined threshold value and a replacement thereof has not been ordered yet.

2. The ordering system according to claim 1,
wherein, even though there is a cartridge whose replacement has not been ordered yet in the cartridges specified by the status information, in a case where the status information received by the receiving unit does not indicate that there is a cartridge whose value of the remaining amount of the recording material is less than the predetermined threshold value, the ordering unit does not order the replacement of the cartridge that has not been ordered yet.

3. The ordering system according to claim 1,
wherein the server system is further equipped with a management unit configured to manage ordering information, which indicates whether or not the replacement has been ordered, and
wherein, with reference to the ordering information, the ordering unit determines whether the replacement of the cartridge has not been ordered yet.

4. The ordering system according to claim 3,
wherein the status information further includes identification information with which the cartridges are identified, and
wherein the ordering information includes information indicating whether replacements of the cartridges identified with the identification information have already been ordered.

5. The ordering system according to claim 4,
wherein the ordering unit updates the ordering information by use of the identification information of the cartridge whose replacement has been ordered.

6. The ordering system according to claim 4,
wherein the ordering unit does not delete the identification information from the ordering information even though the identification information is no longer included in the status information.

7. The ordering system according to claim 1,
wherein, for ordering the replacement of the cartridge that has not been ordered yet, the ordering unit orders a replacement of a cartridge whose remaining amount of the recording material is less than a second threshold value, which is greater than the predetermined threshold value, from among the cartridges mounted on the recording apparatus.

8. A server system comprising:
a receiving unit configured to receive status information, which includes values of remaining amounts of recording materials of cartridges mounted on a recording apparatus, from the recording apparatus, which records an image by use of the recording materials contained in the cartridges; and
an ordering unit configured to provide an instruction for ordering a replacement of a cartridge for which a replacement has not been ordered yet from among the cartridges mounted on the recording apparatus in a case where the status information received by the receiving unit indicates that there is a cartridge whose value of the remaining amount of the recording material is less than a predetermined threshold value and a replacement thereof has not been ordered vet.

9. The server system according to claim 8,
wherein, even though there is a cartridge whose replacement has not been ordered yet in the cartridges specified by the status information, in a case where the status information received by the receiving unit does not indicate that there is a cartridge whose value of the remaining amount of the recording material is less than the predetermined threshold value, the ordering unit does not order the replacement of the cartridge that has not been ordered yet.

10. The server system according to claim 8, further comprising
a management unit configured to manage ordering information, which indicates whether or not the replacement has been ordered,
wherein, with reference to the ordering information, the ordering unit determines whether the replacement of the cartridge has not been ordered yet.

11. The server system according to claim 10,
wherein the status information further includes identification information with which the cartridges are identified, and
wherein the ordering information includes information indicating whether replacements of the cartridges identified with the identification information have already been ordered.

12. The server system according to claim 11,
wherein the ordering unit updates the ordering information by use of the identification information of the cartridge whose replacement has been ordered.

13. The server system according to claim 11,
wherein the ordering unit does not delete the identification information from the ordering information even though the identification information is no longer included in the status information.

14. The server system according to claim 8,
wherein, for ordering the replacement of the cartridge that has not been ordered yet, the ordering unit orders a replacement of a cartridge whose remaining amount of the recording material is less than a second threshold value, which is greater than the predetermined threshold value, from among the cartridges mounted on the recording apparatus.

15. An ordering system including a recording apparatus, which records an image by use of recording materials, and a server system, which is capable of communicating with the recording apparatus,
wherein the recording apparatus sends status information, which includes values of remaining amounts of the recording materials, and
wherein the server system comprises
a receiving unit configured to receive the status information which is sent from the recording apparatus, and
an ordering unit configured to provide an instruction for ordering the recording material for which a replacement has not been ordered yet in a case where the status information received by the receiving unit indicates that the remaining amount of the recording material is less than a predetermined threshold value and a replacement thereof has not been ordered yet.

16. The ordering system according to claim 15.
wherein the server system is further equipped with a management unit configured to manage ordering information, which indicates whether or not the replacement has been ordered, and
wherein, with reference to the ordering information, the ordering unit determines whether the replacement of the recording materials has not been ordered wet.

17. The ordering system according to claim 16,
wherein the status information further includes identification information with which cartridges corresponding to the recording materials are identified, and
wherein the ordering information includes information indicating whether replacements of the cartridges identified with the identification information have already been ordered.

18. The ordering system according to claim 17,
wherein the ordering unit updates the ordering information by use of the identification information of the recording material whose replacement has been ordered.

19. The ordering system according to claim 17,
wherein the ordering unit does not delete the identification information from the ordering information even though the identification information is no longer included in the status information.

20. The ordering system according to claim 15,
wherein, for ordering the replacement of the recording material that has not been ordered yet, the ordering unit orders a replacement of the recording material in a case where the remaining amount of the recording material is less than a second threshold value, which is greater than the predetermined threshold value.
